(19) United States
(12) Patent Application Publication
(10) Pub. No.: US 2012/0037820 A1
(43) Pub. Date: Feb. 16, 2012

(54) OPTICAL ASSEMBLY AND OPTICAL-INFORMATION-READING DEVICE

(75) Inventor: Satoshi Komi, Saitama Pref. (JP)

(73) Assignee: Optoelectronics Co., Ltd., Warabi (JP)

(21) Appl. No.: 13/247,422

(22) Filed: Sep. 28, 2011

Related U.S. Application Data
(63) Continuation of application No. PCT/JP2010/056259, filed on Apr. 6, 2010.

(30) Foreign Application Priority Data
Apr. 6, 2009 (JP) 2009-092237
May 15, 2009 (JP) 2009-119299

(51) Int. Cl. G06K 7/14; G02B 3/12

(52) U.S. Cl. 250/566; 359/665

(57) ABSTRACT

To provide a camera module in which a liquid lens can be fixed with a simple configuration. The camera module 1 is provided with the liquid lens 2, a master lens 3 which is disposed at the same axle as that of the liquid lens 2. A camera body 4 has a lens-mounting portion 40 to which the liquid lens 2 and the master lens 3 are mounted with their optical axes aligned, and a lens cover 5 fixes the liquid lens 2 and the master lens 3 onto the lens-mounting portion 40. A ring-shaped packing 6 which is disposed between the lens cover 5 and the liquid lens 2 pushes the liquid lens 2.

This patent application is a continuation of International Application No. PCT/JP2010/056259 filed Apr. 6, 2010 and designating the United States of America. This international application was published in Japanese on Oct. 14, 2010 under No. WO 2010/117003. This international application is hereby incorporated by reference in its entirety.

### BACKGROUND OF THE INVENTION

The present invention relates to an optical assembly, preferably a liquid-lens-optical assembly, which is equipped with a liquid lens, and an optical-information-reading device which is provided with this liquid-lens-optical assembly.

A bar code, which is one-dimensional code information for use in merchandise control, stock management or the like, has been well known. A two-dimensional code has also been known, as the code that has increased information density. Also known is a method of capturing the two-dimensional code with a solid-state image sensing device such as a CMOS image sensor or a CCD image sensor, as a device reading the two-dimensional code, performing various kinds of processing on such an image and binarizing and decoding.

The CMOS image sensor to be used in a device for reading such code information is no different in function from that with which a digital camera, or the like, is equipped so that it functions similarly to a photographer shooting an object, a scene, or the like. For example, in a case of stock management or the like, it is used for photographing both the object of interest and a location where the object is housed and storing them together with code information on a database.

Further, most portable phones are equipped with a small-sized camera using the above-mentioned CMOS image sensor. The greater part thereof not only has a camera function of the portable phone to photograph a scene or a figure, like a common digital camera, but often also includes a bar code/two-dimensional code scanner and an OCR (optical character reader).

There is a need for a focusing configuration in a device for shooting an image with a solid-state image sensing device, or an automatic focusing configuration, a so-called autofocus function. For the autofocus function, moving a location of a lens along an optical axis mechanically has been known, but it is difficult for a small sized device such as a portable phone to be equipped with such a mechanism. Thus, there is a need for configurations where a lens itself has an autofocus mechanism. As one of them, a liquid lens has been known.

FIG. 8 is a configuration diagram illustrating a liquid lens conceptually. The liquid lens 100 is configured so that water solution 101 having high conductivity and insulating oil 102 are sealed in a container 103 that has two opposed surfaces, each of which has a light-permeable transparent window. The liquid lens 100 is provided with an electrode 104a that contacts the water solution 101 and an electrode 104b that contacts the water solution 101 and the oil 102 both through an insulating portion. When the electrodes 104a, 104b are electrically charged to apply voltage to the water solution 101, a configuration of an interface 105 between the water solution 101 and the oil 102 may be altered. Such a phenomenon is referred to as “electrowetting phenomenon”. It is possible to move a focus position of lens 100 by altering a curvature of the interface 105 between the water solution 101 and the oil 102 so that light passing through the lens can come into focus at different distances from the lens.

Such liquid lenses have been applied to a camera module, a code scanner, and the like, as disclosed, for example, in Patent Document 1 (see below). Providing a temperature sensor to perform a temperature-compensating focusing control also has been disclosed (for example, see Patent Document 2). Further, providing a cooling mechanism for a liquid lens has been disclosed (For example, see Patent Document 3).

### Patent Documents

Patent Document 1: Japanese Patent Application Publication No. 2005-259128
Patent Document 2: Japanese Utility Model Registration No. 3083006
Patent Document 3: Japanese Patent Application Publication No. H08-313783

Since the liquid lens is typically susceptible to any load, it is necessary to have many spacers and/or packing in order to locate or protect a liquid lens. Thus, even when a mechanism for moving the lens mechanically is unnecessary, it is difficult to downsize a device therefor.

The present invention solves such a problem and has an object to provide a liquid-lens-optical assembly which allows a liquid lens to be fixed with a simple configuration, and an optical-information-reading device which is provided with this liquid-lens-optical assembly.

### SUMMARY

In order to solve the above-mentioned problem, embodiments of the present invention include a liquid-lens-optical assembly that is provided with a liquid lens in which fist, liquid and second liquid, which have different optical refractive indexes and are not miscible, form an interface between them, are sealed in a container The liquid lens has a first electrode and a second electrode to which voltage for controlling a configuration of the interface between the first liquid and the second liquid is applied. At least one optical member is disposed along the same axis as that of the liquid lens, so a lens-mounting portion to which the liquid lens and the optical member are mounted aligns them axially. A mounting member fixes the liquid lens and the optical member onto the lens-mounting portion, and a ring-shaped elastic locating member, which is disposed between the mounting member and the liquid lens, pushes the liquid lens under its elastic deformation and absorbs a fluctuation of a load.

Embodiments of the present invention also include an optical-information-reading device that is provided with a liquid lens in which first liquid and second liquid, which have different optical refractive indexes and are not, miscible form an interface between them, are sealed in a container. The liquid lens has a first electrode and a second electrode to which voltage for controlling a configuration of the interface between the first liquid and the second liquid is applied. A photograph-controlling portion has a solid-state image sensing device photoelectrically converting an optical signal passing through the liquid lens. At least one optical member is disposed along the same axis as that of the liquid lens, so that a lens-mounting portion to which the liquid lens and the optical member are mounted aligns them axially A mounting member fixes the liquid lens and the optical member onto the lens-mounting portion, and a ring-shaped elastic locating member, which is disposed between the mounting member and the liquid lens, pushes the liquid lens under its elastic deformation and absorbs a fluctuation of a load.

In the liquid-lens-optical assembly and the optical-information-reading device according to an embodiment of the present invention, by fixing the liquid lens through the elastic locating member, the load applied onto the liquid lens is restrained so that even if there is a tolerance in the parts, a fluctuation of the load is absorbed, thereby allowing avoiding a large increase amount of the load.

Making use of the present invention, the load applied onto the liquid lens is restrained and fluctuation of the load is also restrained so that it is possible to protect the liquid lens and locate it securely. Further, many spacers and/or packing are unnecessary, thereby allowing the device to be downsized.

### BRIEF DESCRIPTION OF THE DRAWINGS

FIG. 1 is a sectional diagram showing an example of a camera module as a present embodiment.

FIG. 2 is an exploded perspective diagram showing an example of the camera module of the present embodiment.

FIG. 3 is an exterior and perspective diagram showing an example of a liquid lens constituting part of the camera module of the present embodiment.

FIG. 4 is a perspective diagram showing an example of a flexible printed circuit substrate constituting part of the camera module of the present embodiment.

FIG. 5A is a plan diagram showing an example of the flexible printed circuit substrate constituting part of the camera module of the present embodiment.

FIG. 5B is a plan diagram showing an example of the flexible printed circuit substrate constituting part of the camera module of the present embodiment.

FIG. 6 is a sectional and perspective diagram showing an example of a packing constituting part of the camera module of the present embodiment.

FIG. 7 is a functional block diagram showing an example of an optical-information-reading device embodying the present invention

FIG. 8 is a configuration diagram for illustrating an example of the liquid lens.

### DETAILED DESCRIPTION OF THE PREFERRED EMBODIMENTS

The following will describe embodiments of a camera module which is equipped with a liquid-lens-optical assembly according to the present invention and an optical-information-reading device which is provided with the camera module with reference to drawings.

### (Configuration Example of Camera Module as Present Embodiment)

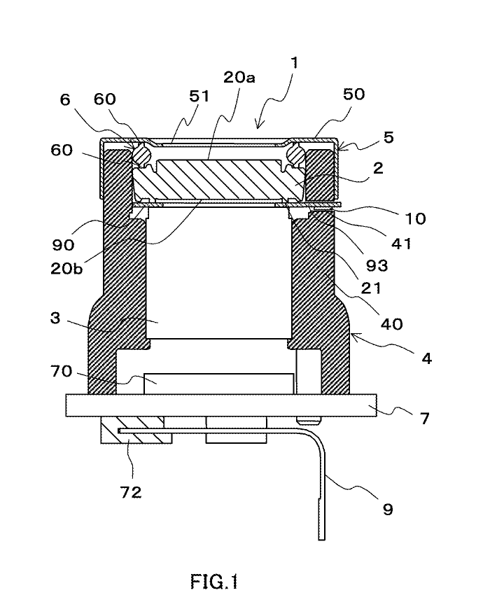

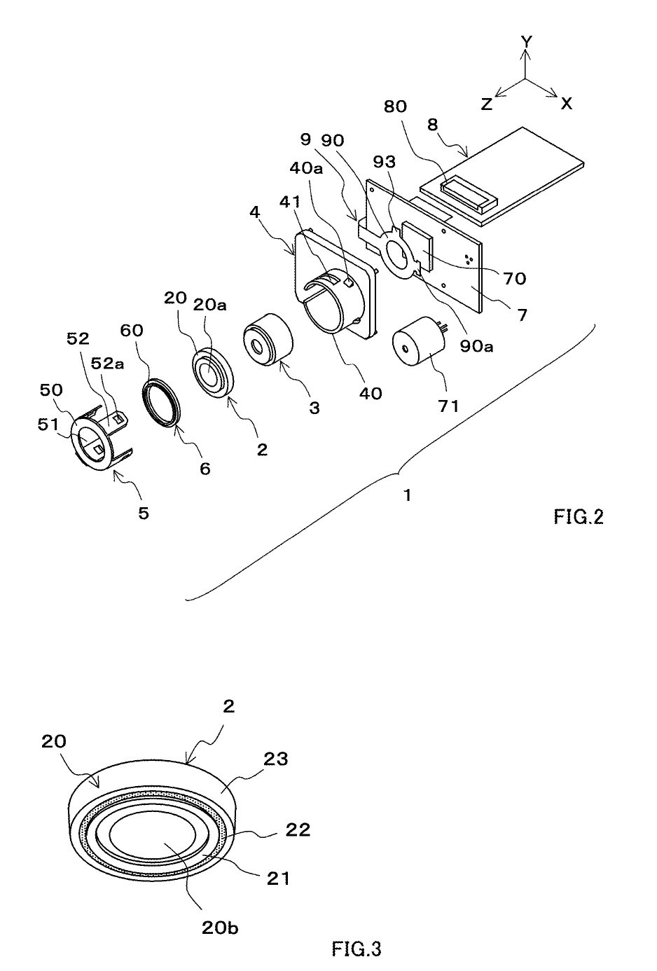

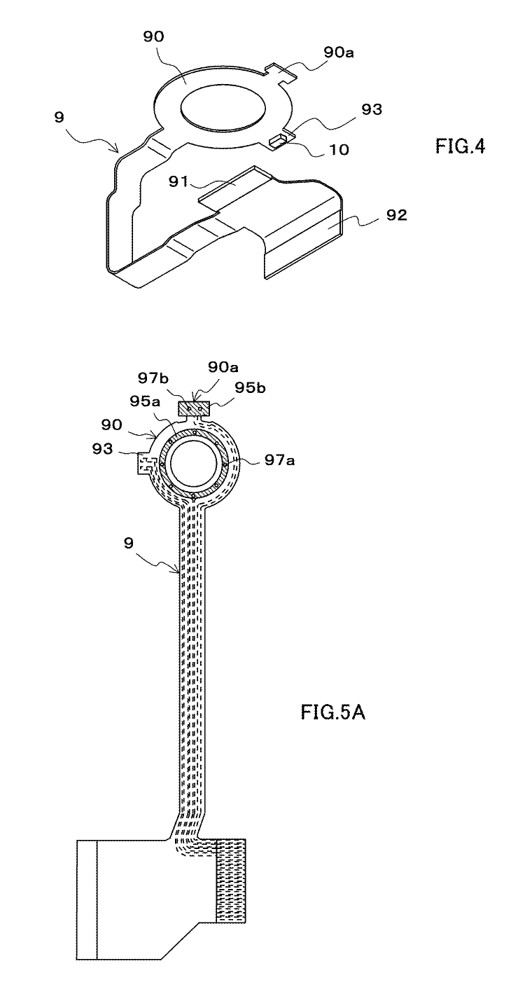

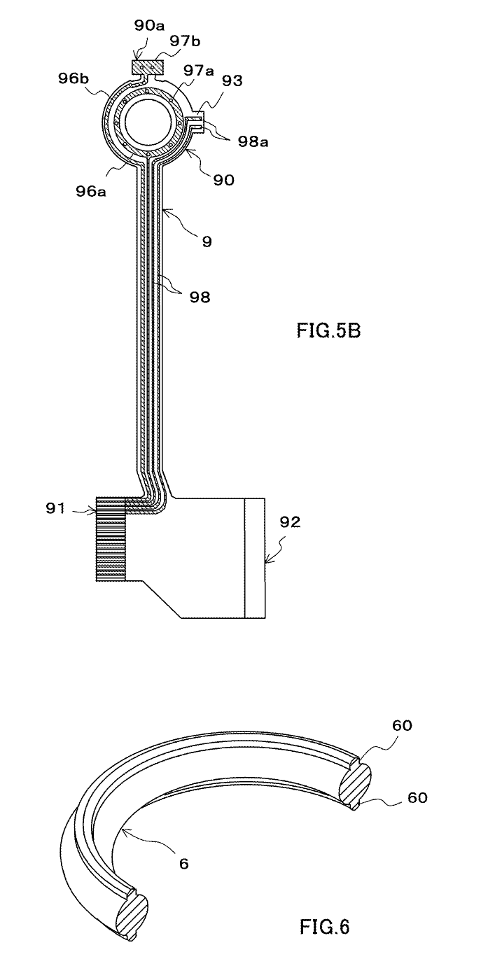

FIG. 1 is a sectional diagram showing an example of the camera module as the present embodiment; FIG. 2 is an exploded perspective diagram showing an example of the camera module as the present embodiment; FIG. 3 is an exterior and perspective diagram showing an example of a liquid lens constituting the camera module as the present embodiment; FIG. 4 is a perspective diagram showing an example of a flexible printed circuit substrate constituting the camera module as the present embodiment; FIGS. 5A and 5B are plan diagrams each showing an example of the flexible printed circuit substrate constituting the camera module as the present embodiment; and FIG. 6 is a sectional and perspective diagram showing an example of a packing constituting the camera module as the present embodiment.

The camera module 1 as the present embodiment is provided with a thermistor 10 detecting a temperature of the periphery of the liquid lens 2 and adjusts a focus position of the liquid lens 2 derived from information on a distance from an object to be measured using information on the temperature detected by the thermistor 10 to realize correct autofocus. In the camera module 1, by providing a flexible printed circuit substrate 9 connected to an electrode of the liquid lens 2 with the thermistor 10, it becomes possible to detect the temperature of the periphery of the liquid lens 2 exactly. Further, by providing a packing 6 for locating the liquid lens 2, the liquid lens 2 is protected.

In the camera module 1 as the present embodiment, the liquid lens 2 and a master lens 3 are mounted to a camera body 4. The liquid lens 2 has a transparent material through which light is transmitted, and high electroconductive aqueous solution that is an example of first liquid and insulating oil that is an example of second liquid are sealed in a cylindrical container 20 in which an incident plane 20a and an exit plane 20b are formed. The inside of the liquid lens 2 has a configuration as; or example, that described in FIG. 8 so that the aqueous solution 101 and the oil 102 are separated from each other at a direction along an optical axis of the liquid lens 2 and are not miscible, to form an interface 105 therebetween through which light is transmitted. The aqueous solution and the oil sealed in the liquid lens 2 have different optical refractive indexes so that light transmitted from the incident plane 20a to the exit plane 20b is refracted at the interface between the aqueous solution and the oil.

In the liquid lens 2, in this embodiment, a first electrode 21 is formed on an outer portion from the exit plane 20b and a second electrode 23, which is insulated from the first electrode 21 through an insulating portion 22, is formed on the whole or a part of a circumference thereof. The first electrode 21 is connected to, for example, the electrode 104a, which has been described on FIG. 8, and the second electrode 23 is connected to the electrode 104b. It is to be noted that, in an alternate configuration, the first electrode 21 may be connected to the electrode 104b and the second electrode 23 may be connected to the electrode 104a. In the liquid lens 2 of this embodiment, in a state where the first electrode 21 and the second electrode 23 are not electrically charged, the interface between the aqueous solution and the oil is kept to a set fixed configuration thereof and then, when the first electrode 21 and the second electrode 23 are electrically charged, the configuration of the interface between the aqueous solution and the oil varies according to voltage applied onto the aqueous solution. This allows a refractive angle of light passing through the lens to vary so that a focus position is switchable.

A master lens is an example of an optical member and is configured so that a single optical lens or plural optical lenses, which are not shown, are enclosed in a cylindrical housing.

The camera body 4 is an example of a supporting member and is provided with a lens-mounting portion 40 in which a cylindrical space that is conformable to configurations of the cylindrical liquid lens 2 and the master lens 3 is formed. When the liquid lens 2 and the master lens 3 are fitted into the lens-mounting portion 40 in stacked arrangement in the direction of the optical axis. Their positions are limited along X-Y axes that are perpendicular to the optical axis, thereby allowing the optical axes of the liquid lens 2 and the master lens 3 to be aligned with each other.

The camera module 1 is provided with a lens cover 5, which is mounted to the lens-mounting portion 40, and the packing 6, which fixes the liquid lens 2 and the master lens 3. The lens cover 5 is provided with a lens-pushing part 50, a window 51 formed radially inward of the lens-pushing part 50 and legs 52 formed radially outward of the lens-pushing part 50. The window 51 of the lens cover 5 is configured so that an opening is formed at a portion thereof that is opposed to the incident plane 20a of the liquid lens 2 and a size of the opening is determined so as not to block the light by the predetermined angle of field.

When the lens cover 5 is mounted on the lens-mounting portion 40, claim portions 40a, formed so as to project from a circumference of the lens-mounting portion 40, are fitted into recess portions 52a provided on the legs 52 of the lens cover 5 so that the lens cover 5 is fixed to the lens-mounting portion 40.

The packing 6 is an example of an elastic locating member and is made of silicon. The packing 6 has a ring shape that is conformable to the shape of an internal circumference of the lens-mounting portion 40 and has ring-shaped protrusions 60 on upper and lower surfaces thereof which are opposed to the incident plane 20a of the liquid lens 2 and the lens-pushing part 50 of the lens cover 5. The packing 6 is configured with its thickness between the protrusions 60 being set so that, when the packing 6 is disposed between the lens cover 5 and the liquid lens 2, which are mounted to the lens-mounting portion 40, one protrusion 60 comes into contact with a portion of the liquid lens 2 radially outward of the incident plane 20a and the other protrusion 60 comes into contact with the lens-pushing part 50 of the lens cover 5.

The camera module 1 is provided with a CMOS substrate 7 mounting a CMOS image sensor 70, which is an example of a solid-state image sensing device photoelectrically converting an optical signal, a main substrate 8 performing signal processing, and the flexible printed circuit (FPC) substrate 9 connecting the liquid lens 2 with the CMOS substrate 7 and the main substrate 8. Onto the CMOS substrate 7, the camera body 4 is attached. On the CMOS substrate 7, a distance-measuring portion 71 having a laser-light-receiving or emitting part or the like is also mounted. On the main substrate 8, a circuit or the like decoding the signal photoelectrically converted by the CMOS image sensor 70 is installed. In this embodiment, the CMOS substrate 7 and the main substrate 8 are formed as separate substrates and constitute a photograph-controlling portion. It, however, is to be noted that the CMOS substrate 7 and the main substrate 8 may be formed as a single substrate.

The flexible printed circuit substrate 9 is an example of wiring member and is provided with a ring-shaped electrode portion 90 with a first electrode pattern 95a, which is an example of a first electrode portion connected to the first electrode 21 of the liquid lens 2, and a second electrode pattern 95b, which is an example of a second electrode portion connected to a second electrode 23 thereof, being formed so as to be insulated from each other on one surface thereof shown in FIG. 5A. The electrode portion 90 is configured to have a shape that is fitted into the lens-mounting potion 40 of the camera body 4. The flexible printed circuit substrate 9 is also provided with an electrode portion 91 connected to a connector 72 of the CMOS substrate 7 and an electrode portion 92 connected to a connector 80 of the main substrate 8.

The flexible printed circuit substrate 9 is configured with a first wiring pattern 96a connected to the first electrode pattern 95a and a second wiring pattern 96b connected to the second electrode pattern 95b being formed so as to be insulated from each other on the other surface thereof shown in FIG. 5B.

The first electrode pattern 95a has a shape that is conformable to a shape of the first electrode 21 of the liquid lens 2. A part of the first wiring pattern 96a formed on the electrode portion 90 has also a ring shape with the same diameter as that of the first electrode pattern 95a.

The first electrode pattern 95a formed on one surface of the flexible printed circuit substrate 9 and the first wiring pattern 96a formed on the other surface of the flexible printed circuit substrate 9 are disposed as to become a ring shape that is conformable to a shape of, for example, the first electrode pattern 95a and they are electrically connected to each other through a plurality of via holes 97a that pass through the flexible printed circuit substrate 9.

In the flexible printed circuit substrate 9, an electrode portion 90a is formed so as to project a part of the circumference of the electrode portion 90 outward so that the second electrode pattern 95b is formed on the electrode portion 90a. A part of the second wiring pattern 96b formed on the electrode portion 90 has an arc shape by way of the exterior of the first wiring pattern 96a and connects the electrode portion 90a.

The flexible printed circuit substrate 9 is an example of connection member and is provided with a ring-shaped electrode portion 90 with a first electrode pattern 95a, which is an example of a first electrode portion connected to the first electrode 21 of the liquid lens 2, and a second electrode pattern 95b, which is an example of a second electrode portion connected to a second electrode 23 thereof, being formed so as to be insulated from each other on one surface thereof shown in FIG. 5A. The electrode portion 90 is configured to have a shape that is fitted into the lens-mounting potion 40 of the camera body 4. The flexible printed circuit substrate 9 is also provided with an electrode portion 91 connected to a connector 72 of the CMOS substrate 7 and an electrode portion 92 connected to a connector 80 of the main substrate 8.

The flexible printed circuit substrate 9 is configured with a first wiring pattern 96a connected to the first electrode pattern 95a and a second wiring pattern 96b connected to the second electrode pattern 95b being formed so as to be insulated from each other on the other surface thereof shown in FIG. 5B.

The first electrode pattern 95a has a shape that is conformable to a shape of the first electrode 21 of the liquid lens 2. A part of the first wiring pattern 96a formed on the electrode portion 90 has also a ring shape with the same diameter as that of the first electrode pattern 95a.

The first electrode pattern 95a formed on one surface of the flexible printed circuit substrate 9 and the first wiring pattern 96a formed on the other surface of the flexible printed circuit substrate 9 are disposed as to become a ring shape that is conformable to a shape of, for example, the first electrode pattern 95a and they are electrically connected to each other through a plurality of holes 97a that pass through the flexible printed circuit substrate 9.

In the flexible printed circuit substrate 9, an electrode portion 90a is formed so as to project a part of the circumference of the electrode portion 90 outward so that the second electrode pattern 95b is formed on the electrode portion 90a. A part of the second wiring pattern 96b formed on the electrode portion 90 has an arc shape by way of the exterior of the first wiring pattern 96a and connects the electrode portion 90a.

Then, the second electrode pattern 95b formed on one surface of the flexible printed circuit substrate 9 and the second wiring pattern 96b formed on the other surface of the flexible printed circuit substrate 9 are electrically connected to each other through a single hole 97b or a plurality of holes 97b that passes or pass through the flexible printed circuit substrate 9.

The camera module 1 is provided with the thermistor 10 detecting the temperature of the liquid lens 2 and the proximity of the liquid lens 2. The thermistor 10 is an example of temperature-detecting means and is installed in a sensor-mounting portion 93 of the flexible printed circuit substrate 9, which is formed so as to project from the electrode portion 90 outward. On the flexible printed circuit substrate 9, a wiring pattern 98 having an electrode pattern 98a for connecting the thermistor 10 is formed on the other surface thereof shown in FIG. 5B and the thermistor 10 is installed in the electrode pattern 98a by soldering or the like. Any information on the temperature detected by the thermistor 10 is transmitted to the main substrate 8 through the flexible printed circuit substrate 9, and it is controlled so that a predetermined voltage is applied across the first electrode pattern 95a and the second electrode pattern 95b of the flexible printed circuit substrate 9.

In the camera module 1, the liquid lens 2 and the master lens 3 are stacked with the first electrode 21 of the liquid lens 2 being opposite master lens 3. The electrode portion 90 of the flexible printed circuit substrate 9 is interposed between the liquid lens 2 and the master lens 3. The liquid lens 2 and the master lens 3, which have been stacked with the electrode portion 90 therebetween, are fitted into the lens-mounting portion 40 of the camera body 4.

When the packing 6 is fitted into the lens-mounting portion 40 between the lens cover 5 and the liquid lens 2 and the lens cover 5 is mounted onto the lens-mounting portion 40, one protrusion 60 of the packing 6 comes into contact with a portion of the liquid lens 2 radially outward from the incident plane 20a and the other protrusion 60 comes into contact with the lens-pushing part 50 of the lens cover 5.

This enables the lens cover 5 and the liquid lens 2 to be located so that a load applied to the liquid lens 2 is minimized, thereby limiting the liquid lens 2 and the master lens 3 by the packing 6 to their locations on the Z-axis direction along the optical axis. The liquid lens 2 is also pushed by the packing 6 toward the master lens 3 so that the first electrode 21 of the liquid lens 2 and the first electrode pattern 95a of the electrode portion 90 are electrically connected to each other. The material of packing 6 is silicon that is easy to be molded and has suitable solidity so that it is suitable for a member supporting the liquid lens 2.

Although the load applied to the liquid lens 2 in the Z-axis direction is regulated so as to be limited up to about 0.5 kg (5N), if a container of the liquid lens other than electrode portions thereof is molded by, for example, plastic materials (ABS resin) when the lens cover is configured so as to push it directly, a load of about several tens kg is applied thereto under a deformation of even 0.1 mm, which exceeds substantially the allowed load of the liquid lens 2.

As opposed to this, it is possible to restrain a fluctuation of a load to about 0.2 kg under the deformation of 0.1 mm by inserting the packing 6 between the liquid lens 2 and the lens cover 5. It is also possible to restrain a load applied to the liquid lens 2 below 0.5 kg and leave no space by configuring so that the packing 6 comes into contact with the liquid lens 2 through its protrusion 60 even if there is a tolerance of about +0.2 mm

When the liquid lens 2, the master lens 3 and the electrode portion 90 of the flexible printed circuit substrate 9 are fitted within an internal circumference of the lens-mounting portion 40, the electrode portion 90a projecting from the electrode portion 90 outward is folded and is positioned between the circumference of the liquid lens 2 and the internal circumference of the lens-mounting portion 40. This enables the second electrode 23 of the liquid lens 2 and the second electrode pattern 95b of the electrode portion 90a to be electrically connected. Fitting the liquid lens 2, the master lens 3 and the electrode portion 90 within the internal circumference of the lens-mounting portion 40 enables the liquid lens 2, the master lens 3 and the electrode portion 90 to be limited in their positions in the X-Y axis direction which is perpendicular to the optical axis. This avoids generating a short circuit between the second electrode 23 of the liquid lens 2 and the first electrode pattern 95a of the electrode portion 90.

Since the thermistor 10 is installed in the sensor-mounting portion 93 projecting from the electrode portion 90 connected to the liquid lens 2 in the flexible printed circuit substrate 9, it is located near the liquid lens 2 after installing the electrode portion 90 between the liquid lens 2 and the master lens 3 and attaching the flexible printed circuit substrate 9 to the lens-mounting portion 40. In the camera body 4, an aperture portion 41 is formed in the lens-mounting portion 40 so as to be conformable to the sensor-mounting portion 93 and the thermistor 10 is mounted in the aperture portion 41 of the lens-mounting portion 40, as shown in FIG. 1.

This enables the thermistor 10 to be disposed nearer to the liquid lens 2 than the outside of the lens-mounting portion 40, thereby allowing the occupied mounting space to be restricted to its minimum. Further, limiting the position of the electrode portion 90 in the inner circumference of the lens-mounting portion 40 restrains the thermistor 10 from colliding with the liquid lens 2, even when disposing the thermistor 10 near the liquid lens 2.

Further, the action of assembling the liquid lens 2, the master lens 3 and the flexible printed circuit substrate 9 into the camera body 4 fixes the thermistor 10 near the liquid lens 2, thereby enabling installing operations to be easily done. Electric connection of thermistor 10 is achieved by the flexible printed circuit substrate 9, so that wiring that is different from the wiring driving the liquid lens 2 is not necessary, simplifying mounting operations.

The camera module 1 is configured so that the camera body 4 is attached to the CMOS substrate 7 and light that is incident on the liquid lens 2 travels through the liquid lens 2 and the master lens 3 to become incident or the CMOS image sensor 70.

### [A Configuration Example of an Optical-Information-Reading Device as the Present Embodiment]

The above-mentioned camera module 1 can form, on the CMOS image sensor 70, an image of a remote object to be photographed by controlling the voltage applied to the liquid lens 2. This voltage is controlled based on the information on the temperature near the liquid lens 2, as detected by the thermistor 10, and the information on the distance from the object to be photographed, as measured by the distance-measuring portion 71. The following will describe the optical-information-reading device equipped with such a camera module 1.

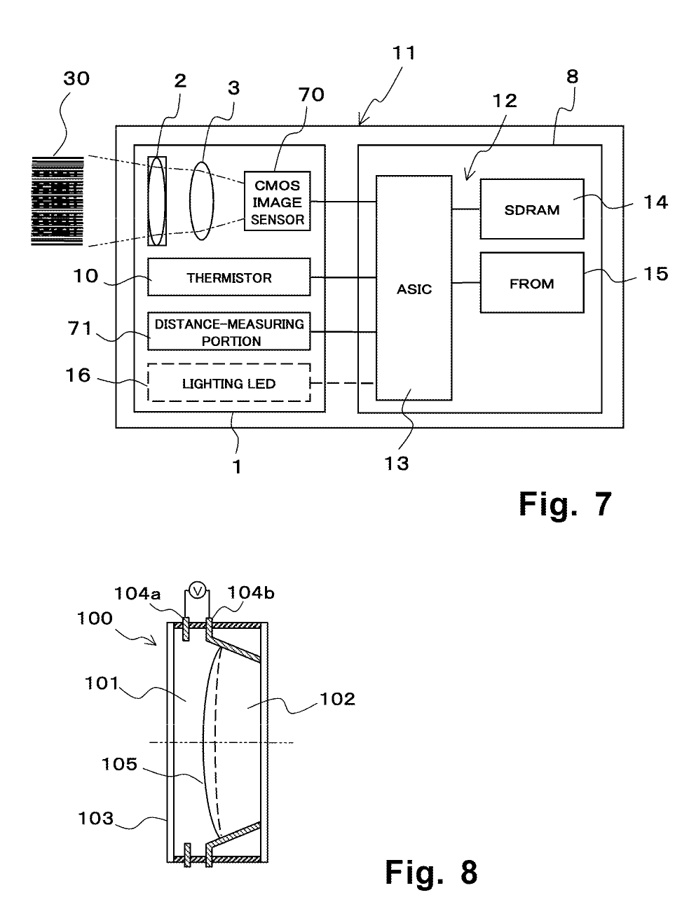

FIG. 7 is a functional block diagram showing an example of the optical-information-reading device as the present embodiment. The optical-information-reading device 11 as the present embodiment is provided with the above-mentioned camera module 1 and a decoder 12 mounted on the main substrate 8. The optical-information-reading device 11 has a configuration so that the above-mentioned components are installed, for example, in a case (not shown), and a user can photograph while he or she holds it in his or her hand.

The decoder 12 is an example of controlling means and is provided with an application specific integrated circuit (ASIC) 13 that controls photographing, adjustment, decoding, data transmission, and the like, to be performed in the camera module 1. In the ASIC 13, writing, reading, and the like, of various kinds of data are performed to/from the SDRAM 14, FROM 15, and the like. The optical-information-reading device 11 is a scanner that is capable of reading a bar code and two-dimensional code but it also can read characters if OCR software is loaded therein.

Here, a lighting LED 16 is provided for irradiating guide light that shows a code symbol 30 to be read but the lighting LED 16 is suitably provided and may be omitted due to a shape of the device or a use purpose thereof. The ASIC 13 also may be a combination of CPU and an LSI such as field programmable gate array (FPGA).

The optical-information-reading device 11 photographs when reflected light from the remote code symbol 30 focuses on the CMOS image sensor 70, namely, so-called focus is performed. This is because it is impossible to decode contents of the code symbol 30 unless the image is clearly captured.

The optical-information-reading device 11 measures the distance from the code symbol 30 to be photographed and controls the liquid lens 2 so as to become focused on the measured distance. For this reason, a distance-measuring portion 71 is provided in the camera module 1. Two technologies for measuring the distance by laser are well known. One is a pulsing technology which obtains a distance by measuring delayed time between a start of laser pulse and a return of reflection thereof. The other is a parallax technology which produces a beam to form a spot on an object to be photographed and measures the position of the detected spot on the object to be photographed. The distance from the object to be photographed is determined from the position of the detected spot. Although the method of measuring the distance is not limited thereto, either of these methods to measure the distance is preferably, programmed in ASIC 13.

A relationship of the voltage applied to the liquid lens 2 and its focus position is previously obtained. This enables voltage information based on a distance to the code symbol 30 measured by the distance-measuring portion 71 to be obtained by storing in the ASIC 13 a relation table of the distance to the code symbol 30 to be photographed and the voltage to be applied to the liquid lens 2.

On the other hand, in the liquid lens 2, the focus position varies due to the temperature thereof even if similar voltage is applied thereto. Thus, a correction table based on periphery temperature of the liquid lens 2 has been stored in the ASIC 13. Although the liquid lens 2 needs a period of waiting time after the voltage is applied thereto and prior to photographing a picture, this period of waiting time varies due to the temperature thereof. Generally, the higher the temperature, the shorter the period of waiting time; for example, the period of waiting time at 60° C. is much shorter than the period of waiting time at 25° C. A relation table of the periphery temperature of the liquid lens 2 and the period of waiting time has been stored in the ASIC 13.

In the camera module 1 according to the present embodiment, a part of the electrode portion 90 of the flexible printed circuit substrate 9 that is connected with the liquid lens 2 projects so as to form the sensor-mounting portion 93, in which the thermistor 10 is installed. This enables the thermistor 10 to be disposed at a place near the liquid lens 2 where it is not subject to influence by heat from the CMOS image sensor 70, other electric circuits and the like, thereby allowing the variation of temperature in the liquid lens 2 itself to be detected by the thermistor 10.

Thus, by referring to the relation table of the distance to the code symbol 30 and the voltage to be applied to the liquid lens 110, the correction table based on the periphery temperature of the liquid lens 2 and the relation table relating the periphery temperature of the liquid lens 2 and the period of waiting time prior to photographing, an optimal focus adjustment is realized so that it is possible to capture a clear picture.

The present invention is applicable to a bar code reader, a two-dimensional code reader or the like, and can realize autofocus with a small device.

### DESCRIPTION OF REFERENCE CODES

1: Camera Module;
2: Liquid Lens;
20: Container;
21: First Electrode;
3: Master Lens;
4: Camera Body,
40: Lens-mounting Portion;
41: Aperture Portion;
5: Lens Cover;
6: Packing;
60: Protrusions;
7: CMOS Substrate;
70: CMOS Image Sensor;
8: Main Substrate;
9: Flexible Printed Circuit Substrate;
90: Electrode portion; and
93: Sensor-mounting Portion

1. A liquid-lens-optical assembly comprising:
a liquid lens including a closed space containing first and second immiscible liquids having different optical refractive indexes and forming an interface between them, first and second electrodes, each in communication with one of the liquids, to which voltage for controlling a configuration of the interface between the first liquid and the second liquid is applied, the liquid lens having an optical axis;
at least one optical member having an optical axis;
a lens-mounting portion to which the liquid lens and the optical member are mounted so that their optical axes are aligned;
a mounting member which fixes the liquid lens and the optical member onto the lens-mounting portion; and
a ring-shaped elastic locating member which is disposed between the mounting member and the liquid lens, pushes the liquid lens upon its elastic deformation and absorbs a fluctuation of a load.

2. The liquid-lens-optical assembly according to claim 1 wherein the elastic locating member has ring-shaped protrusions projecting from surfaces opposed to the liquid lens and the mounting member; and
one of said protrusions contacting the liquid lens and another of said protrusions contacting the mounting member when the elastic locating member is between the liquid lens and the mounting member.

3. The liquid-lens-optical assembly according to claim 1 or 2 characterized in that the elastic locating member is made of silicon.

4. An optical-information-reading device comprising:
a liquid lens including a closed space containing first and second immiscible liquids having different optical refractive indexes and forming an interface between them, first and second electrodes, each in communication with one of the liquids, to which voltage for controlling a configuration of the interface between the first liquid and the second liquid is applied;
a photograph-controlling portion that has a solid-state image sensing device photoelectrically converting an optical signal, the sensing device being positioned so that light propagating through the liquid lens impinges thereon;
at least one optical member having an optical axis;
a lens-mounting portion to which the liquid lens and the optical member are mounted so that their optical axes are aligned;
a mounting member which fixes the liquid lens and the optical member onto the lens-mounting portion; and
a ring-shaped elastic locating member which is disposed between the mounting member and the liquid lens, pushes the liquid lens upon its elastic deformation and absorbs a fluctuation of a load.

5. The optical-information-reading device according to claim 4 further comprising:
a connection member having an electrode portion which is connected to the liquid lens and connecting the liquid lens and the photograph-controlling portion; and
the electrode portion constructed to be conformable to a configuration of the lens-mounting portion and being disposed between the liquid lens and the optical member.

6. The optical-information-reading device according to claim 5 wherein:
the electrode portion has a ring-shaped configuration and is conformable to a configuration of the lens-mounting portion;
the elastic member has ring-shaped protrusions projecting from surfaces opposed to the liquid lens and the mounting member; and
one of said protrusions contacts the liquid lens and another of said protrusions contacts mounting member when the elastic locating member is disposed between the liquid lens and the mounting member.
